(19) United States
(12) Patent Application Publication
(10) Pub. No.: US 2006/0018523 A1
(43) Pub. Date: Jan. 26, 2006

(54) Enrollment apparatus and enrollment method, and authentication apparatus and authentication method

(75) Inventors: Hirofumi Saitoh, Ogaki-city (JP); Keisuke Watanabe, Mizuho-city (JP)

Correspondence Address: MCDERMOTT WILL & EMERY LLP, 600 13TH STREET, N.W., WASHINGTON, DC, 20005-3096, US

(73) Assignee: SANYO ELECTRIC CO., LTD.

(21) Appl. No.: 11/186,878

(22) Filed: Jul. 22, 2005

(30) Foreign Application Priority Data
Jul. 23, 2004 (JP) 2004-216433
Aug. 31, 2004 (JP) 2004-251477

(51) Int. Cl. G06K 9/00

(52) U.S. Cl. 382/124

(57) ABSTRACT

An input unit receives the input a fingerprint image of a user. A classification unit classifies the fingerprint image inputted by the input unit into any of a plurality of groups defined on the basis of individual differences of the fingerprint. Based on the classification result of fingerprint width, namely, the type of a group determined by the classification unit, a switching control unit selects either a normal fingerprint width feature extraction processing unit or a narrow fingerprint width feature extraction processing unit provided in a feature extraction unit. A feature extraction unit processes the fingerprint image, using processing methods defined respectively for the plurality of groups. A verification data preparation unit prepares fingerprint verification data. A fingerprint identification unit checks the fingerprint verification data prepared by an identification data preparation unit against fingerprint identification data enrolled in a biological information storage unit.

### BACKGROUND OF THE INVENTION

1. Field of the Invention

The present invention relates to the registration technique and the authentication technology, and it particularly relates to enrollment method and enrollment apparatus as well as authentication method and authentication apparatus by which to carry out a user authentication using biological information.

2. Description of the Related Art

Biometric authentication uses such biological information as fingerprint, palm print, face image, iris image or voiceprint as the object to be authenticated. In such biometric authentication, parameters or the like for feature extraction are fixed for use at registration and identification of authentication data by tuning them to typical biological information. In fingerprint-based authentication, for instance, threshold values, constants and the like are determined by optimizing the image resolution for image processing and the various parameters for fingerprint feature extraction based on a typical fingerprint, such as a fingerprint of an adult person. In fingerprint identification, therefore, a certain level of identification accuracy is ensured by image processing and feature extraction using the thus optimized set values at enrollment and identification of the user's fingerprint.

Suppose that the feature extraction is done with the same authentication threshold values but using different set values and conditions between registration and identification, then the identification reject rate (false nonmatch rate), which is the probability of not identifying an individual as the same person, will rise. The identification reject rate may be lowered by loosely setting the authentication threshold values. But such loose setting may raise the false identification rate (false match rate), which is the probability of falsely authenticating individuals other than the intended one. In practice, therefore, processing parameters are not changed according to the individual differences of persons to be identified.

Also, in biometric authentication, it takes much time to search the authentication database or perform a verification processing, and for that reason the users are often classified by age or gender to speed up the authentication process (See Japanese Patent Application Laid-Open No. 2002-8035, for instance).

A user authentication system is normally such that the resolution of image processing and the filters for feature extraction are tuned to the typical users. In consequence, there are cases where the system cannot authenticate persons who have fingerprints deviant from the typical ones, such as a fingerprint with finer wrinkles on a smaller finger or a fingerprint on a rough skin. For such users for whom fingerprint identification cannot be used, the user authentication system offers some substitute means like password identification. Such an irregular response, however, goes counter to the original purpose of biometric authentication, which is to raise the level of security. Not only fingerprint authentication but also iris-based authentication or face identification encounters the problem of individual differences that require adjustment of the processing parameters for the individuals to be authenticated. That is, there are, in fact, users who are not compatible with a user authentication system based on typical biological information, and this creates inconvenience in the operation of such a user authentication system. Also, to improve convenience for the users, it is desirable that the authentication process be automated.

### SUMMARY OF THE INVENTION

The present invention has been made in view of the foregoing circumstances and problems, and an object thereof is to provide an identification technology that can also be used with users not compatible with ordinary personal authentication systems because of their nontypical physical characteristics.

In order to solve the above problems, an enrollment apparatus according to a preferred mode of carrying out the present invention comprises: an input unit which inputs biological information to be enrolled; a classification unit which classifies the biological information inputted by the input unit into any of a plurality of groups defined on the basis of individual differences of the biological information; and an enrollment unit which performs enrollment in a manner that the biological information inputted is associated with the classified groups.

According to this mode of carrying out the present invention, the biological information inputted is automatically classified into any of a plurality of groups so that it belongs to the applicable one of the plurality of groups. As a result, the convenience for persons involved in authentication processing can be improved.

The biological information to be inputted to the input unit may be information on a fingerprint, and the classification unit may define the plurality of groups according to a degree of density in the fingerprint. A group into which the information is to be classified can be selected based on the degree of density of the fingerprint.

The classification unit may includes: an extraction unit which extracts the number of ridge lines and the interval thereof in a predetermined region from the inputted information on a fingerprint; and an execution unit which classifies the inputted fingerprint information into any of the plurality of groups, based on the number of ridge lines and the interval thereof extracted by the extraction unit. The density of a fingerprint can be determined based on the number of ridge lines and the interval thereof, so that the fingerprint can be determined with high accuracy. The classification unit may further include a presentation unit which presents to a registrant a classification result carried out by the classification unit. With this presentation unit, the classification result can be presented to the registrant in the ensured manner.

The enrollment apparatus may further comprise a processing unit which extracts features from the classified biological information, based on feature extraction methods defined respectively for the plurality of groups, wherein the enrollment unit may enroll, as the inputted biological information, feature-extracted biological information for each of the plurality of groups. While the biological information inputted is being automatically classified in such a manner as to belong to the applicable one of the plurality of groups, the features are extracted using the feature extraction methods suitable respectively for the plurality of groups. Hence, the convenience for the registrants is improved and at the same time the features can be extracted with high accuracy from the biological information.

Another preferred mode of carrying out the present invention relates also to an enrollment apparatus. This apparatus comprises: an input unit which inputs biological information to be enrolled; and a display unit which classifies and enrolls the inputted biological information into any of a plurality of groups defined according to individual differences of the biological information and which simultaneously displays a classification and enrollment result.

According to this mode of carrying out the present invention, the biological information is enrolled for each of groups classified according to the biological information, so that a predetermined processing can be performed for each of the groups.

Still another preferred mode of carrying out the present invention relates to an authentication apparatus. This apparatus comprises: an input unit which inputs biological information to be authenticated; a classification unit which classifies the biological information inputted by the input unit into any of a plurality of groups defined on the basis of individual differences of the biological information; a processing unit which extracts features from the classified biological information, based on feature extraction methods defined respectively for the plurality of groups; and an authentication unit which enrolls beforehand biological information to be referred to for each of the plurality of groups and which authenticates feature-extracted biological information based on biological information to be referred to enrolled in a group corresponding to the classified biological information among the plurality of groups.

According to this mode of carrying out the present invention, the biological information to be referred to is classified into a plurality of groups and enrolled accordingly and at the same time a group to which the biological information to be authenticated shall belong is automatically determined and the authentication is carried out based on the biological information to be referred to that belongs to the applicable group. Thus, the convenience for persons involved in authentication processing is improved, and at the same time the authentication speed and authentication accuracy can be improved.

Still another preferred mode of carrying out the present invention relates also to an authentication apparatus. This apparatus comprises: an input unit which inputs biological information to be authenticated; and a display unit which authenticates the inputted biological information by classifying them into any of a plurality of groups defined according to individual differences of the biological information and which simultaneously displays a classified and identified result.

According to this mode of carrying out the present invention, the biological information is authenticated for each of groups classified according to the biological information, so that the authentication accuracy is raised and at the same time the authentication processing can be done at high speed.

Still another preferred mode of carrying out the present invention relates to an enrollment method. This method is characterized in that while biological information inputted is being classified into any of a plurality of groups defined according to individual differences of the biological information, features are extracted from the classified biological information by applying feature extraction methods defined respectively for the plurality of groups, and feature-extracted biological information is enrolled for each of the plurality of groups.

Still another preferred mode of carrying out the present invention relates to an authentication method. This method is characterized in that biological information to be referred to is enrolled beforehand for each of a plurality of groups defined on the basis of individual differences of the biological information and while the biological information inputted is being classified into any of the plurality of groups, features are extracted from the classified biological information by applying feature extraction methods defined respectively for the plurality of groups, and feature-extracted biological information is authenticated by referring to biological information to be referred to corresponding to a group that contains the classified biological information.

Still another preferred mode of carrying out the present invention relates to an enrollment apparatus. In this apparatus, the biological information acquired is put into indices and to which of a plurality of groups this index value shall belong is detected wherein the plurality of groups are such that an index value is classified beforehand into a plurality of ranges. This apparatus has a plurality of storage regions respectively associated with the plurality of groups, and records the biological information in a storage region corresponding to the detected group. In so doing, when the index value is close to a boundary of the group, the biological information gathered is separately recoded in two storage regions corresponding respectively to two groups that lie across the boundary.

According to this mode of carrying out the present invention, the biological information is recorded in one or more storage regions corresponding to one or more groups. Even if the group is set in a narrow sense, the biological information which is easily classifiable is recorded in a single storage region whereas the biological information which is hard to be classified is recorded in a plurality of storage regions. If the biological information on a person to be identified is hard-to-be-classified one, the group to be checked is liable to change from one group to another at the time of identification. Even in such a case, the biological information on such a registrant is recorded in a plurality of storage regions, so that the authentication is less likely to fail. As a result, this structure is effective in keeping the authentication accuracy high while the advantage in which the biological information is classified and then enrolled is made full use of.

Still another preferred mode of carrying out the present invention relates also to an enrollment apparatus. In this apparatus, the biological information acquired is put into indices by two kinds of index values consisting of a first index value and a second index value, and to which of a plurality of groups these index values shall belong is detected wherein the plurality of groups are such that an index value is classified beforehand into a plurality of ranges. In this apparatus, the biological information is separately recoded in a storage region associated to a group containing the first index and a storage region associated to a group containing the second index value, respectively.

According to this mode of carrying out the present invention, two or more kinds of index values from different perspectives are calculated for a single piece of biological information without going through the trouble of acquiring a plurality of kinds of biological information. And the biological information is recorded in a plurality of storage regions corresponding to the plurality of index values. For instance, even if the biological information on a person to be verified is rather hard to be classified using the first index value, there are cases where the classification may be easily done by using the second index value. As a result, the authentication is less likely to fail. Thus, this scheme is effective in keeping the authentication accuracy high while the advantage in which the biological information is classified and then enrolled is made full use of.

Furthermore, according to the personal authentication performed based on the biological information enrolled in these enrollment apparatus described above, an authentication apparatus can be provided such that the biological authentication can be carried out with high authentication accuracy while the improvement in authentication speed achieved by ingeniously classifying the biological information is being enjoyed.

It is to be noted that any arbitrary combination of the above-described structural components as well as the expressions according to the present invention changed among a method, an apparatus, a system, a recording medium, a computer program and so forth are all effective as and encompassed by the present embodiments.

### BRIEF DESCRIPTION OF THE DRAWINGS

FIG. 1 illustrates a structure of a fingerprint enrollment apparatus according to a first embodiment of the present invention.

FIGS. 2A and 2B illustrate groups classified by the fingerprint enrollment apparatus shown in FIG. 1.

FIGS. 3A and 3B show examples of display messages to be given by an enrollment result display unit shown in FIG. 3.

FIG. 4 illustrates a structure of a classification unit shown in FIG. 1.

FIG. 5 illustrates a structure of a fingerprint authentication apparatus according to the first embodiment of the present invention.

FIGS. 6A and 6B show display messages to be given by an identification result display unit shown in FIG. 5.

FIG. 7 illustrates a structure of a personal authentication apparatus according to the first embodiment of the present invention.

FIG. 8 is a flowchart showing a fingerprint enrollment procedure by the fingerprint enrollment apparatus shown in FIG. 1.

FIG. 9 is a flowchart showing a fingerprint authentication procedure by the fingerprint authentication apparatus shown in FIG. 5.

FIG. 10 is a functional block diagram for a personal authentication apparatus according to a second embodiment of the present invention.

FIG. 11 illustrates a data structure in a biological information storage unit.

FIG. 12 is a flowchart showing a processing procedure when a fingerprint is enrolled in a personal authentication apparatus.

FIG. 13 is a flowchart showing the first example of a processing procedure in the authentication of fingerprints according to the second embodiment of the present invention.

FIG. 14 is a flowchart showing the second example of a processing procedure in the authentication of fingerprints according to the second embodiment of the present invention.

### DETAILED DESCRIPTION OF THE INVENTION

The invention will now be described based on the following embodiments which do not intend to limit the scope of the present invention but exemplify the invention. All of the features and the combinations thereof described in the embodiments are not necessarily essential to the invention.

### FIRST EMBODIMENT

Before describing the present invention in detail, an outline of the present invention will be described first. A first embodiment of the present invention relates to a fingerprint enrollment apparatus that enrolls the fingerprints of users in advance and a fingerprint authentication apparatus that authenticates their fingerprints. The fingerprint enrollment apparatus according to the first embodiment accepts the fingerprint images of the users and divides them into a group of fingerprints of normal width (hereinafter referred to as “normal fingerprint width group”) and a group of fingerprints of narrower width (hereinafter referred to as “narrow fingerprint width group”). There are a previously defined image processing method for the normal fingerprint width group and that for the narrow fingerprint width group, and the fingerprint enrollment apparatus extracts features of a fingerprint image through an image processing using the image processing method corresponding to the group into which the received fingerprint image is classified. The fingerprint image whose features have been extracted is classified and enrolled into a relevant group as authentication data.

A fingerprint authentication apparatus according to the first embodiment receives the fingerprint images of the users. Then it classifies them in the same way as with the fingerprint enrollment apparatus, and extracts features of each fingerprint image through an image processing of the fingerprint image using the image processing method corresponding to the group into which the received fingerprint image is classified. The fingerprint image whose features have been extracted is now to be used as verification data, and this verification data is authenticated through comparison with the identification data enrolled in advance. It is to be noted here that since identification data are classified and enrolled into their respective groups by the fingerprint enrollment apparatus, the identification data to be used is one corresponding to a group to which the verification data shall properly belong.

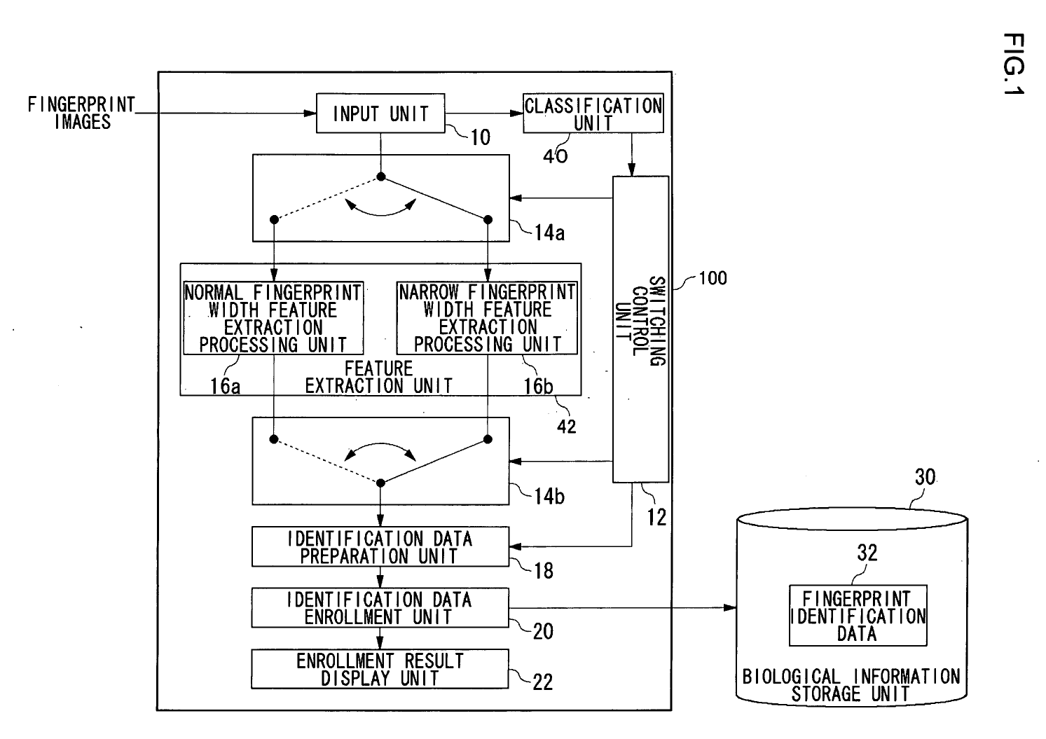

FIG. 1 illustrates a structure of a fingerprint enrollment apparatus 100 according to the first embodiment of the present invention. The fingerprint enrollment apparatus 100 includes an input unit 10, a classification unit 40, a switching control unit 12, a switch 14a, a switch 14b, a feature extraction unit 42, an identification data preparation unit 18, an identification data enrollment unit 20 and an enrollment result display unit 22. The feature extraction unit 42 includes a normal fingerprint width feature extraction processing unit 16a and a narrow fingerprint width feature extraction processing unit 16b. A biological information storage unit 30 contains fingerprint identification data 32.

The input unit 10 accepts information on the fingerprint of a user as the biological information on a person to be enrolled. The information on a fingerprint is, for instance, a fingerprint image digitized by a scanner or the like. The classification unit 40 classifies the inputted fingerprint image into the applicable one of a plurality of groups of fingerprint images which have been defined according to individual differences. In other words, the classification unit 40 decides whether the fingerprint width of a fingerprint image received by the input unit 10 is normal or narrow. The plurality of groups of fingerprint images are defined according to the roughness/fineness of fingerprints or the wideness/narrowness of fingerprints just as the aforementioned “normal fingerprint width group” and “narrow fingerprint width group”.

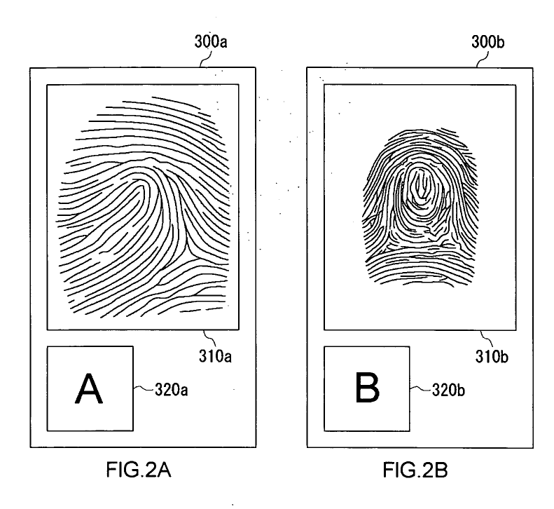

FIGS. 2A and 2B illustrate the groups of fingerprint data, which are classified by a fingerprint enrollment apparatus 100. FIG. 2A is an illustration of fingerprint input data 300a belonging to a user who has a fingerprint of normal width. The fingerprint input data 300a of a normal fingerprint width has a fingerprint image 310a of normal fingerprint width and thus belongs to a normal fingerprint width group 320a. Here, the normal fingerprint width group 320a is denoted by a symbol “A”. On the other hand, FIG. 2B is an illustration of fingerprint input data 300b belonging to a user who has a fingerprint of a narrower than normal width. The fingerprint input: data 300b of a narrow fingerprint width has a fingerprint image 310b of narrow fingerprint width and thus belongs to a narrow fingerprint width group 320b. The narrow fingerprint width group 320b is denoted by a symbol “B”. Here, as mentioned above, the classification unit 40 classifies the fingerprint image into the normal fingerprint width group 320a or the narrow fingerprint width group 320b. Although the method of classification will be described in detail later, the classification unit 40 extracts the number of ridge lines and the interval thereof in a predetermined region from the inputted fingerprint image. Furthermore, based on the extracted number and interval of ridge lines, the classification unit 40 decides whether the fingerprint image belongs to the normal fingerprint width group 320a or the narrow fingerprint width group 320b.

Referring back to FIG. 1, the switching control unit 12 controls switches 14a and 14b based on the result of fingerprint width classification, namely, the group of fingerprints, determined by the classification unit 40 and selects the normal fingerprint width feature extraction processing unit 16a or the narrow fingerprint width feature extraction processing unit 16b, provided in the feature extraction unit 42, as applicable. When a fingerprint belongs to the normal fingerprint width group 320a, input/output of the feature extraction unit 42 is switched to the normal fingerprint width feature extraction processing unit 16a side, whereas when it belongs to the narrow fingerprint width group 320b, input/output of the feature extraction unit 42 is switched to the narrow fingerprint width feature extraction processing unit 16b side.

The feature extraction unit 42 extracts features from a fingerprint image, using the applicable one of the feature extraction methods defined respectively for the plurality of fingerprint width groups. That is, for a fingerprint image 310a of normal fingerprint width, fingerprint feature data such as feature points are extracted by the normal fingerprint width feature extraction processing unit 16a, and for a fingerprint image 310b of narrow fingerprint width, they are extracted by the narrow fingerprint width feature extraction processing unit 16b, before the fingerprint feature data thus extracted are outputted by the feature extraction unit 42. For example, different window sizes to be used at the extraction of fingerprint feature data from a fingerprint image are specified for the normal fingerprint width feature extraction processor 16a and the narrow fingerprint width feature extraction processor 16b so that the window size for the former is larger than that for the latter. Different algorithms for the extraction of fingerprint feature data from a fingerprint image may be used for the normal fingerprint width feature extraction processing unit 16a and the narrow fingerprint width feature extraction processing unit 16b. In this manner, it is preferable that at least partially different feature extraction methods be used for the normal fingerprint width feature extraction processing unit 16a and the narrow fingerprint width feature extraction processing unit 16b.

The identification data preparation unit 18 prepares fingerprint identification data 32 which hold both the fingerprint feature data extracted by the feature extraction unit 42 and the fingerprint width group selected by the switching control unit 12 in a predetermined format. The identification data enrollment unit 20 enrolls fingerprint identification data 32 in the biological information storage unit 30 respectively under a plurality of fingerprint groups. That is, fingerprint identification data 32 belonging to the normal fingerprint width group 320a are enrolled in the region corresponding to the normal fingerprint width group 320a in the biological information storage unit 30, and those belonging to the narrow fingerprint width group 320b are enrolled in the region corresponding to the narrow fingerprint width group 320b in the biological information storage unit 30. It is to be noted that these regions may be separated from one another either physically or logically.

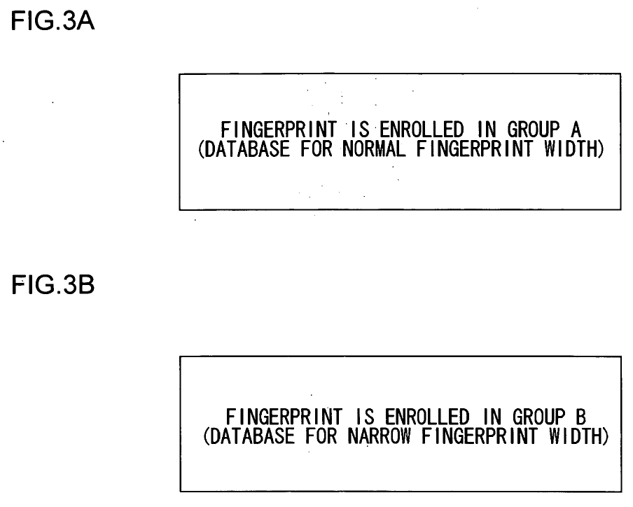

The enrollment result display unit 22 indicates to the user the completion of fingerprint enrollment on a display or the like. The enrollment result display unit 22 also displays a message requesting the user to enter a fingerprint image again when the features could not be extracted adequately and therefore an enrollment has not been accomplished due to an ill-defined fingerprint image. Furthermore, the enrollment result display unit 22 may indicate the result of classification by the classification unit 40, that is, whether the fingerprint belongs to the normal fingerprint width group 320a or the narrow fingerprint width group 320b. FIGS. 3A and 3B show examples of display messages to be given by the enrollment result display unit 22. FIG. 3A represents the case where an inputted fingerprint image belongs to the normal fingerprint width group 320a, and FIG. 3B represents the case where it belongs to the narrow fingerprint width group 320b. It is to be noted here that the enrollment result display unit 22 may not only give such messages on a display or the like but also convey them to a PC (personal computer) or the like via a network (not shown).

In terms of hardware, such a structure as above can be realized by a CPU, a memory and other LSIs of an arbitrary computer. In terms of software, it can be realized by memory-loaded programs or the like, but drawn and described herein are function blocks that are realized in cooperation with those. Thus, it is understood by those skilled in the art that these function blocks can be realized in a variety of forms such as by hardware only, software only or the combination thereof.

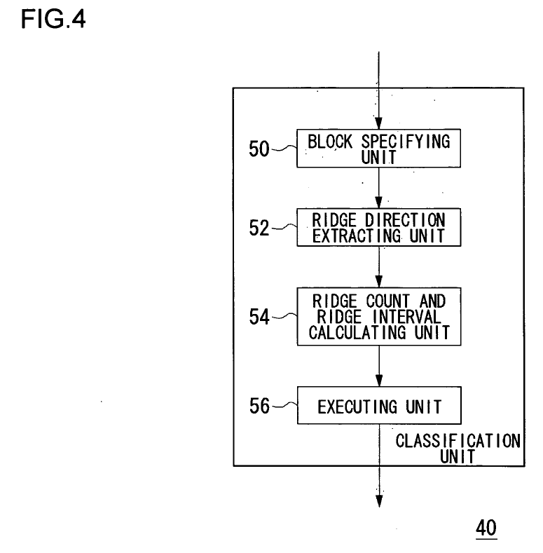

FIG. 4 illustrates a structure of a classification unit 40. The classification unit 40 includes a block specifying unit 50, a ridge direction extracting unit 52, a ridge count and interval calculating unit 54 and an executing unit 56. The block specifying unit 50 extracts a block in an inputted fingerprint image where the fingerprint image exists. For instance, the central area of the fingerprint image is extracted. To extract the central area of the fingerprint image, the block specifying unit 50 divides the fingerprint image into small-sized regions and calculates the averages of the pixel values of fingerprint image contained in the respective regions. The block specifying unit 50 then chooses a region with a large pixel value as the center of the fingerprint image by comparing the averaged pixel values with one another. And the block specifying unit 50 specifies as the block an area with a predetermined width centering around the central region of the fingerprint image.

The ridge direction extracting unit 52 derives the ridge direction of a fingerprint. The ridge direction may be the tangential direction of ridges, for instance. The ridge count and interval calculating unit 54 calculates the number of ridges and the interval thereof in the direction vertical to the derived ridge direction within the specified block. The executing unit 56 classifies the inputted fingerprint image into an applicable group based on the ridge direction, ridge count and ridge interval. In other words, the ridge count and the ridge interval are corrected according to the ridge direction. For instance, the ridge count and the ridge interval when the ridges are rotated in such a manner as to be in a predetermined direction are derived. Then the ridge count and interval thus corrected are compared with a predetermined threshold value to decide whether the inputted fingerprint image belongs to the normal fingerprint width group 320a or the narrow fingerprint width group 320b.

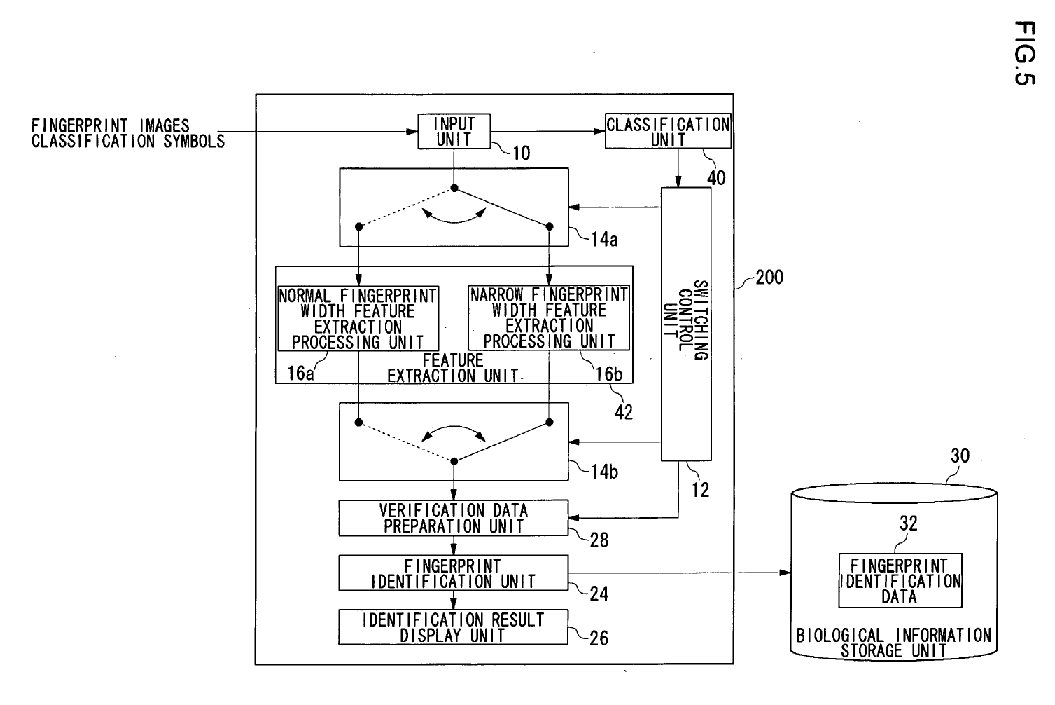

FIG. 5 illustrates a structure of a fingerprint authentication apparatus 200 according to the first embodiment of the present invention. The fingerprint authentication apparatus 200 includes an input unit 10, a classification unit 40, a switching control unit 12, a switch 14a, a switch 14b, a feature extraction unit 42, a verification data preparation unit 28, a fingerprint identification unit 24 and an identification result display unit 26. The feature extraction unit 42 includes a normal fingerprint width feature extraction processing unit 16a and a narrow fingerprint width feature extraction processing unit 16b. A biological information storage unit 30 contains fingerprint identification data 32.

These function blocks may be realized in various forms by hardware only, by software only or by a combination thereof. The fingerprint authentication apparatus 200 makes a fingerprint identification of the user in response to the input of a fingerprint image by him/her. Of the structure of the fingerprint authentication apparatus 200, the input unit 10, the classification unit 40, the switching control unit 12, the switch 14a, the switch 14b and the feature extraction unit 42 are the same as those with the same reference numerals of the fingerprint enrollment apparatus 100 shown in FIG. 1, and therefore their repeated explanation is omitted herein.

The verification data preparation unit 28 prepares fingerprint verification data which hold both the fingerprint feature data extracted by the feature extraction unit 42 and the fingerprint width group selected by the switching control unit 12 in a predetermined format. The fingerprint identification unit 24 compares the fingerprint verification data prepared by the verification data preparation unit 28 with the fingerprint identification data 32 enrolled in the biological information storage unit 30 to see if there is any match. In particular, the fingerprint identification unit 24 verifies the fingerprint verification data based on the fingerprint identification data 32 enrolled in the fingerprint width group selected by the switching control unit 12 from the plurality of fingerprint width groups. For example, if the fingerprint verification data belong to the normal fingerprint width group 320a, then the fingerprint identification unit 24 will carry out an authentication using the fingerprint identification data 32 enrolled in the normal fingerprint width group 320a of the biological information storage unit 30. The authentication may be carried out by examining the correspondence between the line segments connecting feature points contained in each of the fingerprint identification data 32 and the fingerprint verification data.

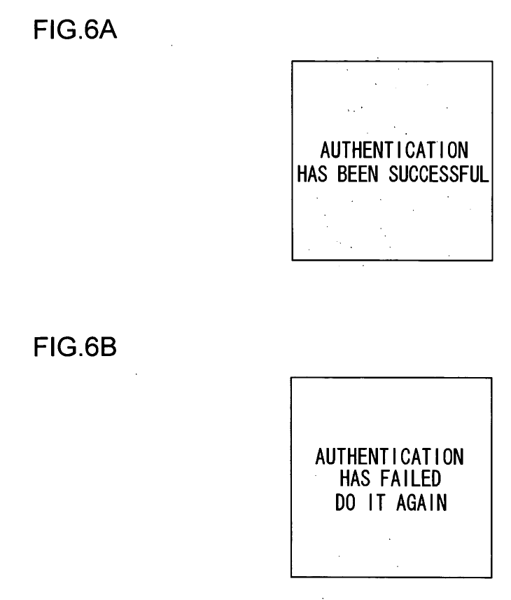

When a fingerprint is judged to belong to an enrolled user as a result of verification by the fingerprint identification unit 24, the identification result display unit 26 displays a message for the user indicating the success of authentication. On the other hand, when a fingerprint has no match among the fingerprints of all the enrolled users, the identification result display unit 26 displays a message for the user indicating the failure of authentication. FIGS. 6A and 6B show examples of display messages to be given by the identification result display unit 26. FIG. 6A represents the case where authentication has been successful, and FIG. 6B the case where authentication has been unsuccessful. It is to be noted here that the authentication result display unit 26 may not only give such messages on a display or the like but also convey them to a PC (personal computer) or the like via a network (not shown).

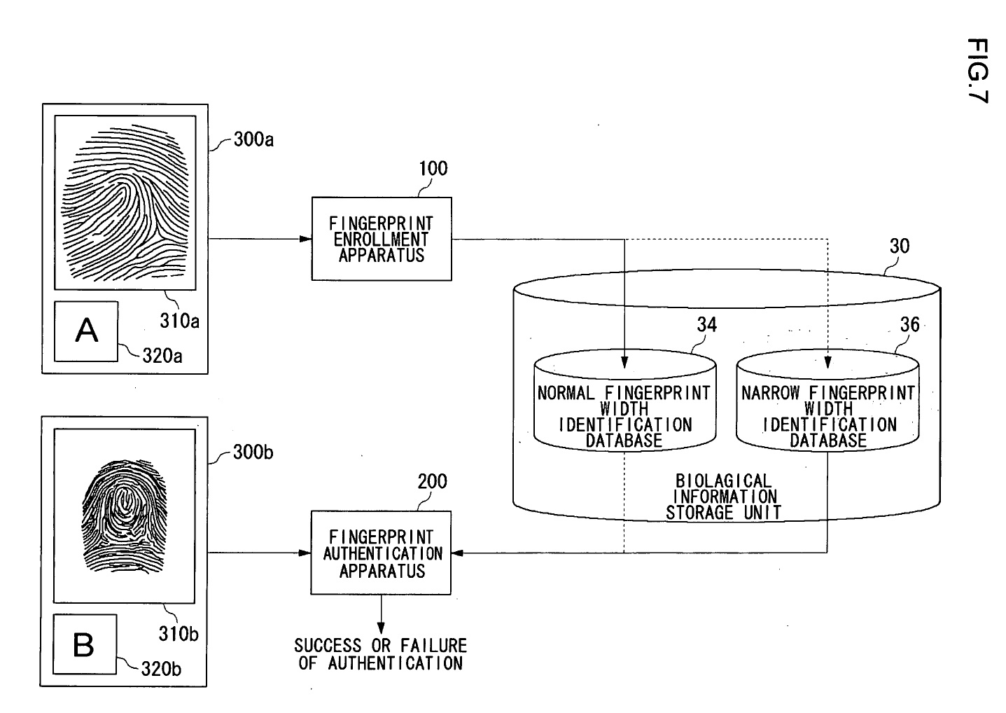

FIG. 7 illustrates a, structure of a personal authentication apparatus according to the first embodiment of the present invention. This identity authentication system is so structured that a fingerprint enrollment apparatus 100 as shown in FIG. 1 and a fingerprint authentication apparatus 200 as shown in FIG. 2 access and share a biological information storage unit 30. The biological information storage unit 30 is so structured that a normal fingerprint width identification database 34 and a narrow fingerprint width identification database 36 are stored in physically or logically separate regions. Here, the normal fingerprint width identification database 34 is a database corresponding to the aforementioned normal fingerprint width group 320a, whereas the narrow fingerprint width identification database 36 is a database corresponding to the aforementioned narrow fingerprint width group 320b.

At the time of registration, a user inputs a fingerprint image to the fingerprint enrollment apparatus 100, and thereupon the fingerprint enrollment apparatus 100 classifies the inputted fingerprint image as fingerprint input data 300a of normal fingerprint width, prepares fingerprint identification data 32 using the feature extraction processing for normal fingerprint width, and enrolls the thus prepared data in the normal fingerprint width identification database 34.

At the time of authentication, another user inputs a fingerprint image to the fingerprint authentication apparatus 200, and thereupon the fingerprint authentication apparatus 200 classifies the inputted fingerprint image as fingerprint input data 300b of narrow fingerprint width, prepares fingerprint verification data using the feature extraction processing for narrow fingerprint width, compares it with the fingerprint identification data 32 for enrolled users of the narrow fingerprint width identification database 36 and displays a message indicating the success or failure of authentication.

Since the biological information storage unit 30 is divided into two databases, namely, the normal fingerprint width identification database 34 and the narrow fingerprint width identification database 36, according to the fingerprint width, this system presents such advantages as high-speed search due to the halved amount of verification and improved identification accuracy on account of the limited amount of verification.

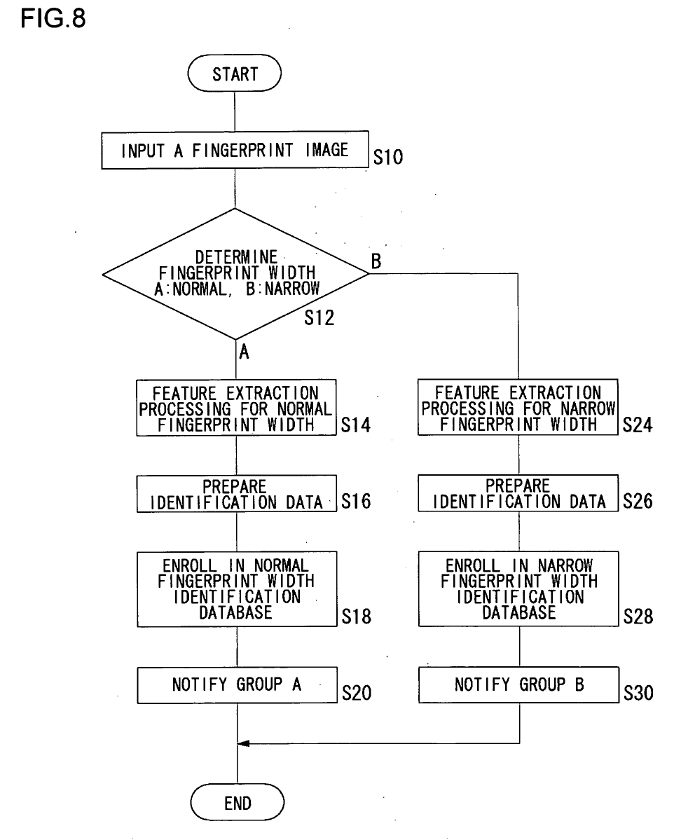

A fingerprint enrollment procedure and a fingerprint authentication procedure by the user authentication apparatus structured as above will be described hereinbleow. FIG. 8 is a flowchart showing a fingerprint enrollment procedure by the fingerprint enrollment apparatus 100. A fingerprint image is inputted from a user to the input unit 10 of the fingerprint enrollment apparatus 100 (S10). The classification unit 40 determines the fingerprint width based on the inputted fingerprint image (S12). If the classification unit 40 judges it to be normal fingerprint width (A of S12), the feature extraction unit 42 performs a feature extraction processing for the normal fingerprint width on the fingerprint image (S14). And the identification data preparation unit 18 prepares the fingerprint identification data based on the extracted fingerprint feature data (S16), and the identification data enrollment unit 20 enrolls the fingerprint identification data 32 in the normal fingerprint width identification database 34 (S18). The enrollment result display unit 22 notifies the user of a group “A” of normal fingerprint width (S20).

If the classification unit 40 determines it to be narrow fingerprint width (B of S12), the feature extraction unit 42 performs a feature extraction processing for narrow fingerprint on the fingerprint image (S24). And the identification data preparation unit 18 prepares the fingerprint identification data based on the extracted fingerprint feature data (S26), and the identification data enrollment unit 20 enrolls the fingerprint identification data 32 in the narrow fingerprint width identification database 36 (S28). The enrollment result display unit 22 notifies the user of a group “B” of normal fingerprint width (S30).

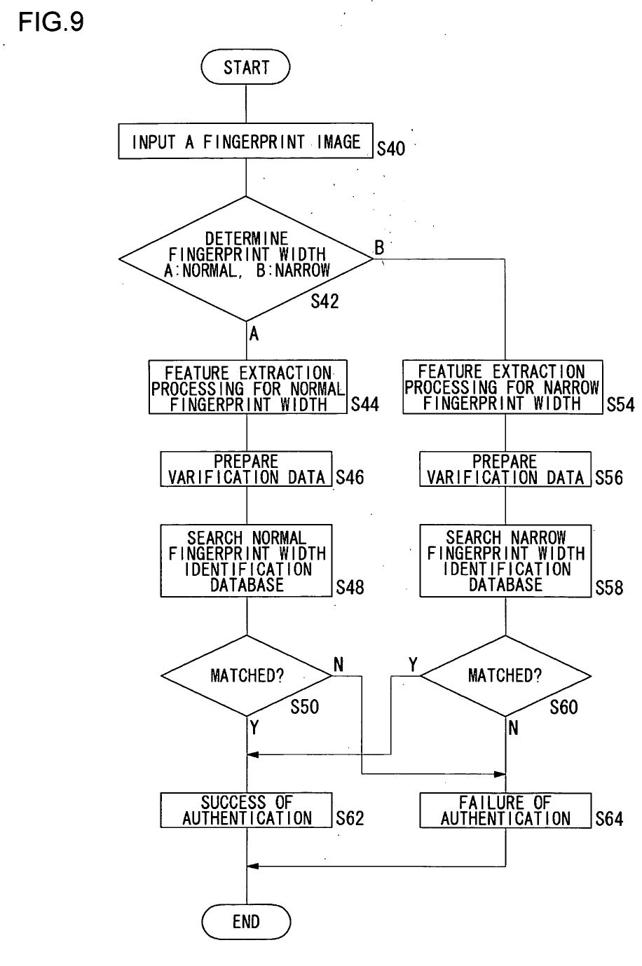

FIG. 9 is a flowchart showing a fingerprint authentication procedure by the fingerprint authentication apparatus 200. A fingerprint image is inputted from a user to the input unit 10 of the fingerprint authentication apparatus 200 (S40). The classification unit 40 determines the fingerprint width based on the inputted fingerprint image (S42). Described here is a procedure taken if the classification unit 40 judges it to be normal fingerprint width (A of S42). The feature extraction unit 42 performs a feature extraction processing for the normal fingerprint width on the fingerprint image (S44). And the verification data preparation unit 28 prepares the fingerprint verification data based on the extracted fingerprint feature data (S46). The fingerprint identification 24 searches the normal fingerprint width identification database 34 (S48), and compares the fingerprint verification data with fingerprint identification data 32 which have already been enrolled (S50). As a result of comparison, if fingerprint identification data 32 fit into the fingerprint verification data exist in the normal fingerprint width identification database 34 (Y of S50), the identification result display unit 26 notifies the user of the success of authentication (S62). And if fingerprint identification data 32 fit into the fingerprint verification-data do not exist in the normal fingerprint width identification database 34 (N of S50), the identification result display unit 26 notifies the user of the failure of authentication (S64)

Described next is a procedure taken if the classification unit 40 judges the fingerprint width to be normal fingerprint width (B of S42). The feature extraction unit 42 performs a feature extraction processing for the narrow fingerprint width on the fingerprint image (S54). And the verification data preparation unit 28 prepares the fingerprint verification data based on the extracted fingerprint feature data (S56). The fingerprint identification 24 searches the narrow fingerprint width identification database 36 (S58), and compares the fingerprint verification data with fingerprint identification data 32 which have already been enrolled (S60). As a result of comparison, if fingerprint identification data 32 fit into the fingerprint verification data exist in the narrow fingerprint width identification database 36 (Y of S60), the identification result display unit 26 notifies the user of the success of authentication (S62). And if fingerprint identification data 32 fit into the fingerprint verification data do not exist in the narrow fingerprint width identification database 36 (N of S60), the identification result display unit 26 notifies the user of the failure of authentication (S64).

According to the first embodiment, the inputted fingerprint image is automatically classified in such a manner as to belong to the applicable one of a plurality of groups and at the same time the fingerprint feature data are extracted using the feature extraction methods suitable for the respective groups. Thus, the convenience of a user is improved and at the same time the fingerprint feature data can be extracted with high accuracy. Furthermore, the feature extraction method to extract the fingerprint feature data is changed according to the degree of density in fingerprints, so that an extraction method suitable for the condition of a fingerprint can be carried out. Furthermore, the number of ridge lines and the interval thereof is determined according to the density of fingerprints, so that the fingerprints can be determined accurately. Furthermore, the classified group can be reliably presented to the user.

The fingerprint identification data are enrolled by classifying them into a plurality of groups. At the same time a group to which the fingerprint verification data are to belong is automatically decided and the authentication is conducted based on the verification fingerprint data that actually belongs to the applicable group. As a result, the convenience of a user is improved and at the same time the search efficiency and authentication accuracy are improved. The resolution for image processing as well as the filter through which to extract feature points are switched to those suitable for the fingerprint width. This absorbs the differences in the physical characteristics and thus can identify the much larger number of users. The search efficiency and the authentication accuracy can be improved by separating physically or logically the fingerprint identification data per classification.

A structure according to the first embodiment is such that the fingerprint enrollment apparatus 100 and the fingerprint authentication apparatus 200 are separately provided. The structure may be of such an integrally combined type that the fingerprint enrollment apparatus 100 is contained in the fingerprint authentication apparatus 200. In such a case, the input unit 10, the switching control unit 12, the switches 14a and 14b, the feature extraction unit 42 and the like can be put to the common use, so that the structure of an personal authentication apparatus can be simplified.

In the first embodiment, the classification unit 40 specifies as a plurality of groups the two groups which are the normal fingerprint width group 320a and the narrow fingerprint width group 320b. However, how to specify the groups is not limited thereto, and three or more groups may be defined, for instance. For example, three or more groups may be specified in a manner such that fingerprint data are classified into a plurality of stages in accordance with the degree of density in fingerprints. According to this modification, the fingerprint images can be classified in further detail.

In the first embodiment, the identification data enrollment unit 20 enrolls the fingerprint identification data 32 in the biological information storage unit 30 for each of a plurality of fingerprint groups. At this point, the fingerprint identification data 32 contain the fingerprint feature data extracted by the feature extraction unit 42. However, what the identification data enrollment unit 20 operates to do is not limited thereto, and the identification data enrollment unit 20 may enroll the fingerprint identification data 32 containing the fingerprint images as they are, instead of the fingerprint identification data 32 containing the fingerprint feature data. In this case, too, the classification may be conducted according to the degree of density in fingerprints. That is, a storage area in the biological information storage unit 30 may be divided into regions per classification so as to enroll a user's fingerprint image. And the identification data enrollment unit 20 may enroll the fingerprint image inputted to a corresponding divided storage region in the biological information storage unit 30, based on the classification determined by the classification unit 40. According to this modification, the classification processing performed at the registration of fingerprint images is automated, so that the convenience for a user can be improved. That is, it is preferable that data be classified into any of a plurality of groups.

### SECOND EMBODIMENT

In a personal authentication apparatus based on biological information, when the biological information on a person to be authenticated (hereinafter, “person to be authenticated” will be referred to as “person to be verified” or “authenticatee” also) is compared with that on a person to be enrolled (hereinafter, “person to be enrolled” will be referred to simply as “registrant”) and then they coincide to the degree that the physiological characteristics thereof can be authenticated as the person in question, the person to be authenticated is authenticated. In the enrollment apparatus according to the first embodiment, the respective pieces of information on a plurality of registrants are classified beforehand into a plurality of groups and are then enrolled in the applicable one of the groups so as to speed up the authentication processing. For instance, if such information is a fingerprint, it can be classified into a plurality of groups in terms of the width, pattern, termination point or bifurcation point of ridge line, and the like. If, at the time of authentication, a decision is made on which group the biological information on a person to be authenticated belongs to and, thereafter, the only biological information recorded on the registrant associated with the thus determined group is to be checked, the authentication processing can be performed much faster than performing the comparison processing on all the registrants.

As the biological information is classified into groups more finely, the number of data to be compared with the user's biological information can be reduced. Nevertheless, there is a possibility that a fingerprint might be classified into a group different from a proper group depending on conditions when the biological information is collected from a person to be authenticated. For example, the pressure of a finger against a sensor in acquiring a fingerprint is not necessarily constant. Thus there is a possibility that the group might be decided all differently depending on a condition when the fingerprints are taken. Also, the biological information itself changes over the years. Thus, at the time of authentication it may possibly be classified into a group different from that determined at the time of fingerprint enrollment. In such a case, the authentication of a person to be identified will fail, which should have been successful in the first place.

Taking the above factors into consideration, a second embodiment provides a personal authentication technique by optimally enrolling the biological information.

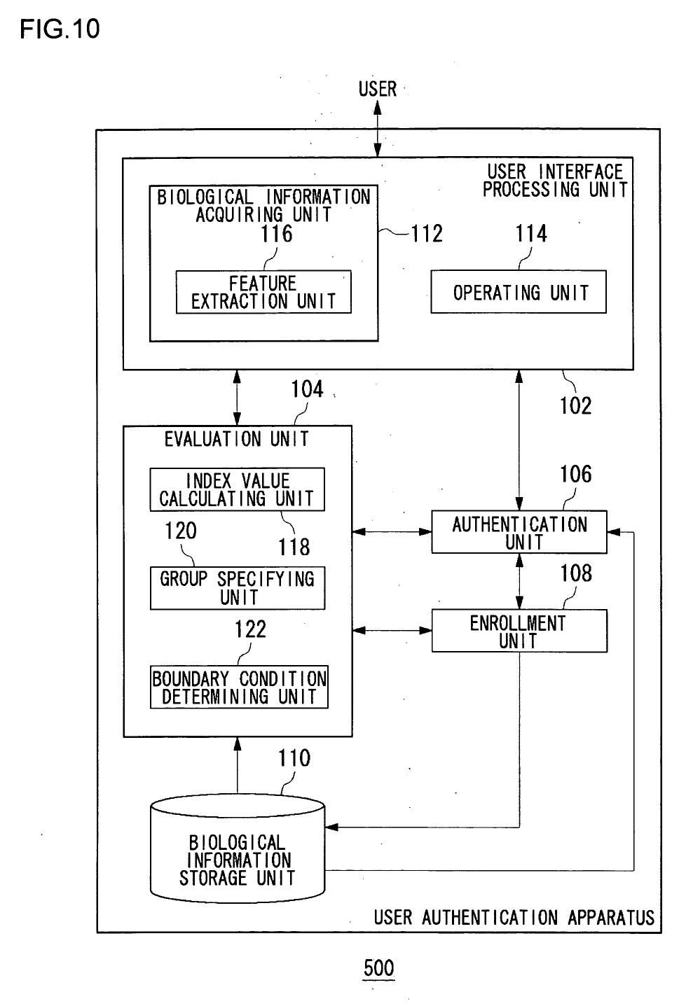

FIG. 10 is a functional block diagram for a personal authentication apparatus according to a second embodiment. In this second embodiment, a description will be given where fingerprint information serves as an example of biological information to be processed.

In terms of hardware, each block shown here can be realized by elements of a computer,. such as a CPU, and a mechanical device. In terms of software, it can be realized by computer programs or the like, but drawn and described herein are function blocks that are realized in cooperation with those. Thus, it is understood by those skilled in the art that these function blocks can be realized in a variety of forms such as by hardware only, software only or the combination thereof.

A personal authentication apparatus 500 includes a user interface processing unit 102, an evaluation unit 104, an authentication unit 106, an enrollment unit 108 and a biological information storage unit 110.

The user interface processing unit 102 takes charge of performing an interface processing. The evaluation unit 104 classifies the fingerprint information acquired via the user interface processing unit 102, according to the feature thereof. The “fingerprint information” mentioned above may be a fingerprint image itself or processed information in which physiological characteristics are extracted from the fingerprint image to identify an individual. The biological information storage unit 110 stores the fingerprint information of a registrant. The enrollment unit 108 records the fingerprint information acquired from the user interface processing unit 102 in the biological information storage unit 106, according to a classification conducted by the evaluation unit 104. The authentication unit 106 checks the fingerprint information acquired from a person to be authenticated against that of a registrant stored in the biological information storage unit 110 so as to perform an authentication processing. The authentication unit 106 decides the success or failure of authentication based on whether or not in these pieces of fingerprint information the physiological features to identify an individual coincide with the information on an authenticatee to the degree that they can be safely authenticated as a registered person.

The user interface processing unit 102 includes a biological information acquiring unit 112 and an operating unit 114. The biological information acquiring unit 112 acquires, as biological information, a fingerprint image from a user. The biological information acquiring unit 112 further includes a feature extraction unit 116. The feature extraction unit 116 extracts, from the fingerprint image, physiological features which are effective for authenticating an individual. The physiological features in the fingerprint image include the ridge shape of a fingerprint, feature points such as the termination point or bifurcation point of a ridge line, directional vectors of ridge line at a predetermined point on a ridge line and the width of ridge or the interval thereof, for example. The operating unit 114 receives operations from the user. The “operation” mentioned here includes an instruction as to the start or termination of acquiring the fingerprint information, for example. Besides the already mentioned functions, the user interface processing unit 102 may be equipped with notification functions by which various kinds of information is displayed to the user or the audio is outputted. For instance, the acquisition of biological information or the completion of authentication may be notified to the user via the LED, screen display, audio or the like.

The evaluation unit 104 includes an index value calculating unit 118, a group specifying unit 120 and a boundary condition determining unit 122.

The index value calculating unit 118 puts into indices the physiological features of a fingerprint extracted by the feature extraction unit 116. The values put into indices will be simply called “index values” hereinafter. For example, a fingerprint image is binarized into a black area and a white area, based on a predetermined threshold value, so that the indexing may be done using the area ratio thereof. Alternatively, the number of termination points or bifurcation points of a fingerprint may serve as the index value. According the second embodiment, two kinds of indices, namely, a first index value and a second index value are calculated for a single piece of index information, from such various aspects as mentioned above. As a modification, many more kinds of index values may also be calculated.

An index value is classified into a plurality of groups. For instance, if the first index value takes on the values ranging from 0 to 100, the groups are set beforehand corresponding respectively to predetermined ranges in such a manner, for example, that the groups are classified by “greater than or equal to 0 and less than 10”, “greater than or equal to 10 and less than 20” and so forth. In the similar manner, the groups are set for the second index value. In what is to follow, if it is intended that a distinction be made between the group of first index values and that of the second index values, they will be particularly called “group of first kind” and “group of second kind”.

The group specifying unit 120 detects to which group the index value calculated by the index value calculating unit 118 belongs. The biological information storage unit 110 has a plurality of storage regions that correspond to these groups, respectively. The biological information storage unit 110 has a plurality of storage regions (hereinafter referred to as “storage regions of first kind”) which correspond respectively to a plurality of groups of first kind, and a plurality of storage regions (hereinafter referred to as “storage regions of second kind”) which correspond respectively to a plurality of groups of second kind. The biological information storage unit 110 may realize these storage regions by employing a structure of array type or list type. For instance, if ten groups are each set as the groups of first kind and the groups of second kind, then ten regions are each set as the storage regions of first kind and the storage regions of second kind.

The boundary condition determining unit 122 determines whether a boundary condition holds or not, based on whether the index value calculated by the index value calculating unit 118 is close to the boundary of the group specified by the group specifying unit 120 or not. The boundary condition determining unit 122 determines respectively whether the respective boundary conditions for the groups of first kind and the groups of second kind hold or not. For instance, if the first index value is “15”, the group of first kind which indicates the range of “greater than or equal to 10 and less than 20” is specified. Then, since this first index value does not lie within “3” from “10” or “20”, namely, “greater than or equal to 10 and less than 13” or “greater than or equal to 17 or less than 20”, the boundary condition does not hold. If, on the other hand, the index value of first kind is “18”, the boundary condition holds this time. When the boundary condition holds, the group specifying unit 120 specifies two groups which lie across the boundary. In the example mentioned just above, if the first index value is “18”, the range of “greater than or equal to 20 or less than 30” will also be one to be specified as the group of first kind, in addition to the range of “greater than or less than 10 and less than 20”.

The enrollment unit 108 enrolls the fingerprint image in a storage region, of the biological information storage unit 110, corresponding to the group specified by the group specifying unit 120. That is, the enrollment unit 108 enrolls the fingerprint information in storage regions of first kind and storage regions of second kind, respectively. For instance, if the boundary condition holds for the first index value and it does not hold for the second index value, the enrollment unit 108 records the fingerprint information in the total of three storage regions consisting of two storage regions of first kind and one storage region of second kind.

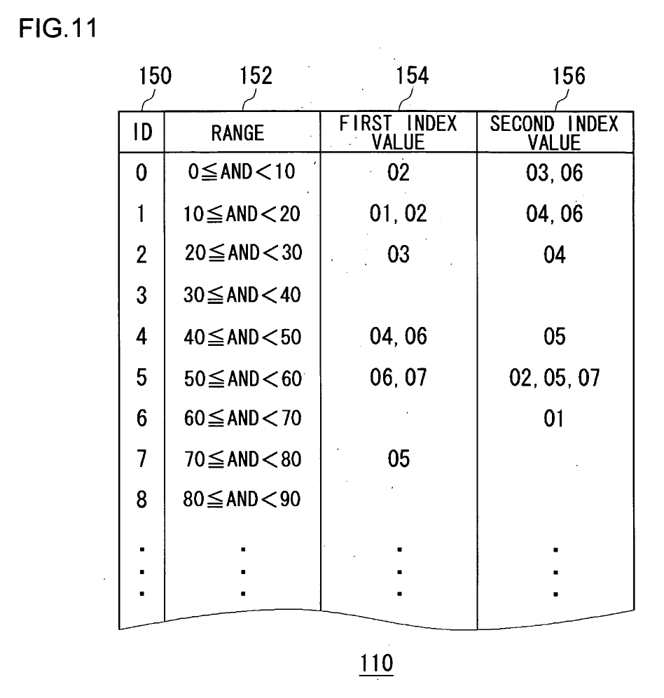

FIG. 11 illustrates a data structure in a biological information storage unit 110.

In the biological information storage unit 110, the storage area is divided and classified into a plurality of storage regions that correspond to a plurality of groups. A range ID column 150 shows IDs by which to identify each group (hereinafter referred to as “range ID”). A group column 152 shows the range of index values belonging to a group. For instance, the range ID “0” corresponds to a group in which the index values lie in the range of “greater than or equal to 0 and less than 10” (this is expressed as “0≦AND<20” in FIG. 11). The range ID “1” corresponds to a group in which the index values lie in the range of “greater than or equal to 10 and less than 20”.

A first index value column 154 indicates a registrant relevant to the first index value, and a second index value column 156 indicates a registrant relevant to the second index value. In the first index value column 154 and the second index value column 156, IDs by which to specify a registrant (hereinafter referred to as “registrant ID”) are recorded. For instance, the first index value about the fingerprint information on a registrant of the registrant ID “01” corresponds to the range ID “1”, namely, “greater than or equal to 10 and less than 20”. In other words, the range ID of the group of first kind under which this registrant falls is “1”. On the other hand, the second index value about the fingerprint information of the same registrant of the registrant ID “01” corresponds to “greater than or equal to 60 and less than 70” of the range ID “6”. In other words, the range ID of the group of second kind corresponds to “6”. The first index value about the fingerprint information on a registrant of the registrant ID “02” is recorded in both the range ID “0” and the range ID “1” in the group of first kind. A plurality of groups of first kind are specified as values to be checked because the boundary condition for the first index value of this registrant holds true there.

The group specifying unit 120 determines to which group the index value calculated by the index value calculating unit 118 belongs to, by referring to the group column 152. If the boundary condition is determined to hold true by the boundary condition determining unit 122, the group specifying unit 120 specifies two groups that surround or lie across the boundary, by the group column 152. The fingerprint information is enrolled in a region corresponding to the thus specified group.

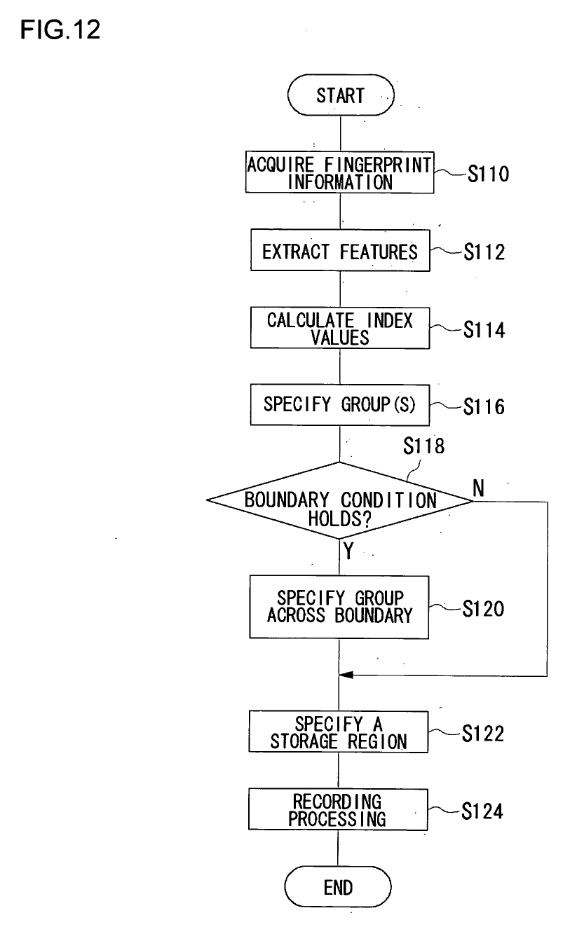

FIG. 12 is a flowchart showing a processing procedure when a fingerprint is enrolled in a personal authentication apparatus.

First, a user presses a surface of his/her thumb against a fingerprint sensor. The biological information acquiring unit 112 acquires, as user's fingerprint information, a fingerprint image via this fingerprint sensor (S110). The fingerprint sensor may be a well-known sensor such as an optical sensor or a pressure-sensitive sensor. The personal authentication apparatus 500 may include therein a fingerprint sensor itself or may receive the fingerprint image acquired by an external fingerprint sensor via a communication line. The feature extraction unit 116 extracts from the acquired fingerprint image a physiological feature by which to identify an individual (S112). The index value calculating unit 118 calculates the first index value and the second index value based on the extracted physiological feature (S114). By referring to the group column 152, the group specifying unit 120 specifies the group of first kind and the group of second kind for the respective index values (S116).

Next, the boundary condition determining unit 122 determines whether a boundary condition holds for each of the groups specified (S118). If the boundary condition holds (Y of S118), the group specifying unit 120 specifies two groups that surround the boundary (S120). If the boundary condition does not hold (N of S118), the processing of S120 will be skipped. For instance, if the boundary condition for the groups of first kind holds, then two groups of first kind are specified and if the boundary condition of the group of second kind does not hold, then a single group of second kind will be specified. As a result, three groups will have been specified in this case.

As another concrete example, suppose that the boundary condition holds if the index value is within “3” from the boundary value of a group. Here, suppose also that the first index value and the second index value calculated by the index value calculating unit 118 based on the biological information of a fingerprint is “11” and “54”, respectively. Then, the group specifying unit 120 specifies the group-of-first-kind range ID and the group-of-second-kind range ID as “1” and “5”, respectively. Since the first index value lies within 3 from the boundary value “10” of the group of first kind “greater than or equal to 10 and less than 20”, the boundary condition determining unit 122 determines that the boundary condition holds true. The group specifying unit 120 specifies also the range ID “0”, in addition to the range ID “1”, as a group of first kind corresponding to the first index value “11”. On the other hand, the boundary condition does not hold true for the group of second kind. Hence, the group of second kind belongs to the range ID “5” only. As a result, the total of three groups is identified.

The enrollment unit 108 specifies storage regions corresponding to a plurality of groups specified in Step S116 or S120 (S122). The enrollment unit 108 records the acquired fingerprint information in each of the specified storage regions (S124). In this manner, the fingerprint information is enrolled in a plurality of storage regions of the biological information storage unit 110. As for the example mentioned above, the result is that the same fingerprint information is recorded in the three different storage regions.

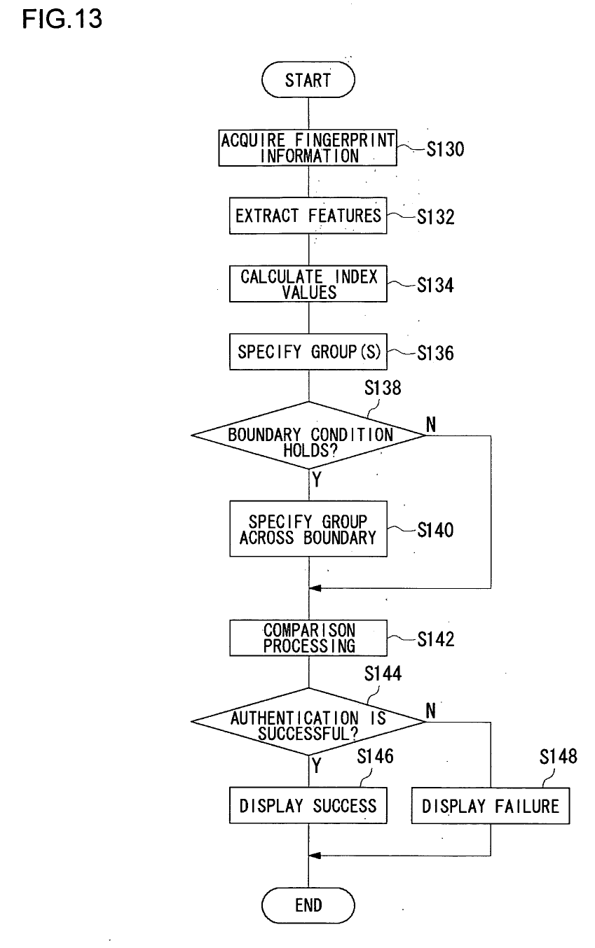

FIG. 13 is a flowchart showing the first example of a processing procedure in the authentication of fingerprints.

The biological information acquiring unit 112 acquires, as fingerprint information, a fingerprint image of a person to be identified (S130). The feature extraction unit 116 extracts from this acquired fingerprint image a physiological feature to identify an individual (S132). The index calculating unit 118 calculates the first index value and the second index value based on this extracted physiological feature (S134). The group specifying unit 120 specifies applicable first and second groups (S136). The boundary condition determining unit 122 decides whether a boundary condition holds for each index value or not (S138). If the boundary condition holds (Y of S138), the group specifying unit 120 specifies two groups that lie across the boundary (S140). If the boundary condition does not hold (N of S138), the processing of S140 is skipped. In this manner, one on more groups are specified for each of the first index value and the second index value.

The authentication unit 106 specifies a storage region of first kind and a storage region of second kind corresponding to the group of first kind and the group of second kind specified in S136 or S140. The authentication unit 106 checks the fingerprint information enrolled in a plurality of these storage regions against the fingerprint information acquired in Step S130, and then checks if they coincide to the degree that the physiological feature matches to identify a registrant (S142). When a registrant corresponding to an authenticatee can be identified for the fingerprint information recorded in either a storage region of first kind or a storage region of second kind, the authentication unit may determine the authentication to be successful. Alternatively, authentication may be determined successful on the condition that a registrant corresponding to an authenticatee can be identified for the fingerprint information recorded respectively in both a storage region of first kind and a storage region of second kind. When the authentication is successful (Y of S144), the user interface processing unit 102 indicates to the authenticatee that the authentication has been successful (S146). When unsuccessful (N of S144), the user interface processing unit 102 indicates to the authenticate that the authentication has failed.

According to such a mode of carrying out the present invention as the second embodiment described above, the fingerprint information is recorded in a plurality of storage regions based on a plurality of index values. As for index information which is rather hard to be classified in terms of a predetermined index value, a plurality of groups are specified as described in Step S120, and a plurality of storage regions are to be enrolled as described in Step S122. Thus, the authentication accuracy can be kept high while the advantage of the classification scheme is made full use of. For instance, if the first index value defies classification as to the fingerprint information on an autheticatee, a boundary condition holds and therefore a plurality of storage regions are to be checked. To this end, even if an intended group is likely to change from one to another due to an acquisition condition of a fingerprint or circumstances such as weather at the time of authentication, an identification processing can be carried out optimally.

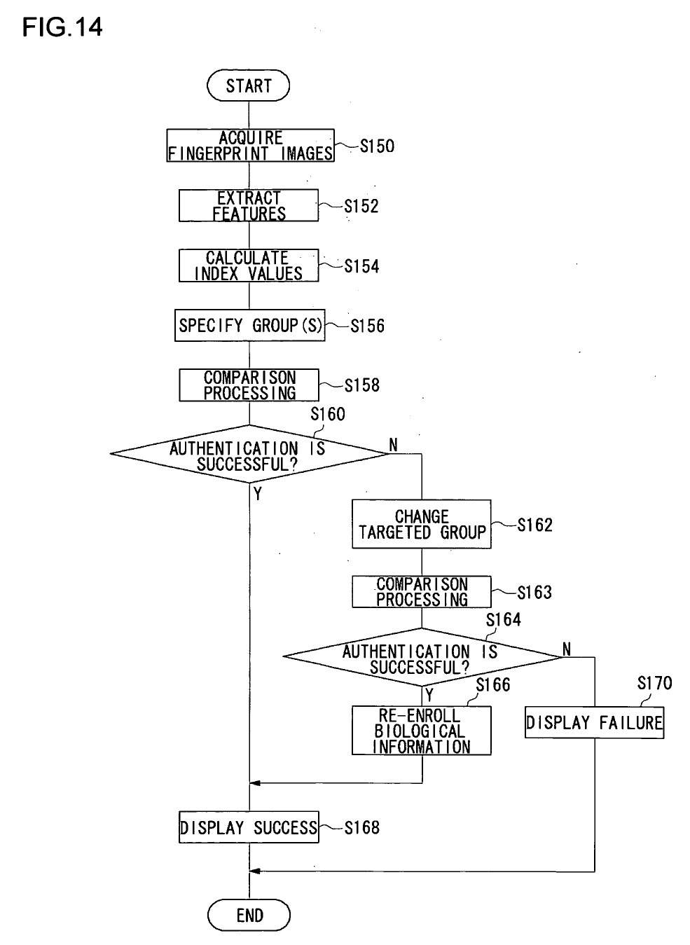

FIG. 14 is a flowchart showing the second example of a processing procedure in the authentication of fingerprints.

The processing steps from S150 through S156 are similar to those from S130 through 136, respectively, described with reference to FIG. 13. When a group is specified in Step S156, the authentication unit 106 checks the fingerprint information on an authenticatee against the fingerprint information on a registrant recorded in the group (S158). Here, it is supposed that authentication is determined successful only if the registrant corresponding to an authenticatee can be specified for the fingerprint information recorded in both the storage region of first kind and the storage region of second kind.

If authentication is successful (Y of S160), the user interface processing unit 102 indicates that the authentication has been successful (S168). If the authentication is unsuccessful (N of S160), the group specifying unit 120 changes the group on which a comparison processing is to be performed (S162). The authentication unit 106 extends the coverage of a comparison processing to be performed to a storage region corresponding to a newly specified group, and carries out another comparison processing (S163).

For instance, if a registrant corresponding to an authenticatee cannot be identified for fingerprint information recorded in a storage region of first kind, the group specifying unit 120 extends the coverage of a comparison processing so that the other storage regions of first kind are also subjected to this comparison processing. In Step S162, the group specifying unit 120 may change the comparison coverage so that all of the groups of first kind are subjected to the comparison processing. Or, the group specifying unit 120 may change the comparison coverage so that a group of first kind adjacent to the group of first kind specified in Step S156 is also subjected to a comparison processing. Here, a change is made in a manner such that two groups of first kind adjacent to the group of first kind specified in Step S156 are now subjected to the comparison processing.

As an example of the above, suppose that a registrant corresponding to an authenticatee can be identified in a storage region of second kind corresponding to a group of second kind specified in Step S156. On the other hand, suppose that the registrant corresponding to the authenticatee cannot be identified in a storage region of first kind corresponding to a group of first kind specified in Step S156. In this case, in Step S162 the group specifying unit 120 newly specifies two groups of first kind adjacent to the group of first kind specified in Step S156. Then in Step S163, the fingerprint information enrolled in the storage regions of first kind corresponding to these groups of first kind is compared with the fingerprint information on an authenticatee.

If the identification of the registrant corresponding to the authenticatee is successful in the newly specified storage regions on which the comparison processing is to be performed and therefore the authentication is successful (Y of S164), the enrollment unit 108 deletes the fingerprint information recorded in the storage regions with which the authentication has been successful and re-registers the fingerprint information acquired in Step S150 in the storage region corresponding to the group specified in Step S156 (S166). Then the user interface processing unit 102 indicates that the biological authentication has been successful (S166). If, on the other hand, the authentication is unsuccessful in Step S164 (N of S164), the user interface processing unit 102 indicates that the authentication has been unsuccessful (S170).

If a registrant is authenticated successfully in Step S164, the group corresponding to the fingerprint information on an authenticatee will differ from the applicable group at the time of enrollment. In such a case, the fingerprint information acquired at the time of enrollment is re-registered in a storage region corresponding to a group determined when the acquired fingerprint information is authenticated.

The biological information is information which is effective in identifying an individual. However, it may change as a person grows older. For instance, as a child grows over the years, the size of a finger changes and, along with this change, the interval of ridge lines changes also. For this reason, there is a probability that the first index value and/or the second index value changes in comparison with those obtained at the time of enrollment and therefore the applicable group itself changes to a different group. According to the second embodiment, even when the authentication is not successful in Step S160, another identification processing is still possible by comparing the acquired information with biological information on a registrant stored in a different storage region or different storage regions. Furthermore, the most recent fingerprint information acquired at authentication is re-registered and updated in a storage region corresponding to a new group specified in Step S156. Thus, every time the identification processing is carried out, the applicable group can be corrected. As a result, the structure and method employed in the second embodiment can automatically cope with the deterioration with age, so that the high authentication accuracy can be retained for the long period of time. From the first time enrollment on, the biological information is subjected to a re-registration processing as necessary at every occasion of verification, so that there can be provided a user authentication apparatus 500 which is highly utilizable to the user.

The present invention has been described based on some embodiments which are only exemplary. It is understood by those skilled in the art that there exist other various modifications to the combination of each component and process described above and that such modifications are within the scope of the present invention.

As such modifications, the user authentication apparatus has been described above using the fingerprint identification as an example. However, the present invention is also applicable to any type of authentication using such biological information as palm print, face image, iris image, retina image, venous information or voiceprint. For example, in the case of identifying palm print, data may be loosely classified by adult/child, gender, wideness of a finger and so forth, so that the resolution or the like can be optimized in accordance with the resulting classification. In the case of identifying iris, data may be roughly sorted out respectively by different colors of eyes, so that the image processing method in actual use can be switched. In the case of voiceprint, data may be classified by pitch of voice, gender, adult/child, age group and so forth, so that the parameters for voice recognition and the like can be adjusted per classification.

What is claimed is:

1. An enrollment apparatus, comprising:
an input unit which inputs biological information to be enrolled;
a classification unit which classifies the biological information inputted by said input unit into any of a plurality of groups defined on the basis of individual differences of the biological information; and
an enrollment unit which performs enrollment in a manner that the biological information inputted is associated with the classified groups.

2. An enrollment apparatus according to claim 1, wherein the biological information to be inputted to said input unit is information on a fingerprint, and
wherein said classification unit defines the plurality of groups according to a degree of density in the fingerprint.

3. An enrollment apparatus according to claim 2, wherein said classification unit includes:
an extraction unit which extracts the number of ridge lines and the interval thereof in a predetermined region from the inputted information on a fingerprint; and
an execution unit which classifies the inputted fingerprint information into any of the plurality of groups, based on the number of ridge lines and the interval thereof extracted by said extraction unit.

4. An enrollment apparatus according to claim 1, further comprising a processing unit which extracts features from the classified biological information, based on feature extraction methods defined respectively for the plurality of groups,
wherein said enrollment unit enrolls, as the inputted biological information, feature-extracted biological information for each of the plurality of groups.

5. An enrollment apparatus according to claim 2, further comprising a processing unit which extracts features from the classified biological information, using feature extraction methods defined respectively for the plurality of groups,
wherein said enrollment unit enrolls, as the inputted biological information, feature-extracted biological information for each of the plurality of groups.

6. An enrollment apparatus according to claim 3, further comprising a processing unit which extracts features from the classified biological information, using feature extraction methods defined respectively for the plurality of groups,
wherein said enrollment unit enrolls, as the inputted biological information, feature-extracted biological information for each of the plurality of groups.

7. An enrollment apparatus, comprising:
an input unit which inputs biological information to be enrolled; and
a display unit which classifies and enrolls the inputted biological information into any of a plurality of groups defined according to individual differences of the biological information and which simultaneously displays a classification and enrollment result.

8. An authentication apparatus, comprising:
an input unit which inputs biological information to be authenticated;
a classification unit which classifies the biological information inputted by said input unit into any of a plurality of groups defined on the basis of individual differences of the biological information;
a processing unit which extracts features from the classified biological information, based on feature extraction methods defined respectively for the plurality of groups; and
an authentication unit which enrolls beforehand biological information to be referred to for each of the plurality of groups and which authenticates feature-extracted biological information based on biological information to be referred to enrolled in a group corresponding to the classified biological information among the plurality of groups.

9. An authentication apparatus according to claim 8, wherein the biological information to be inputted to said input unit is information on a fingerprint, and
wherein said classification unit defines the plurality of groups according to a degree of density in the fingerprint.

10. An authentication apparatus according to claim 8, wherein said classification unit includes:
an extraction unit which extracts the number of ridge lines and the interval thereof in a predetermined region from the inputted information of a fingerprint; and
an execution unit which classifies the inputted fingerprint information into any of the plurality of groups, based on the number of ridge lines and the interval thereof extracted by the extraction unit.

11. An authentication apparatus, comprising:
an input unit which inputs biological information to be identified; and
a display unit which authenticates the inputted biological information by classifying them into any of a plurality of groups defined according to individual differences of the biological information and which simultaneously displays a classified and identified result.

12. An enrollment method characterized in that while biological information inputted is being classified into any of a plurality of groups defined according to individual differences of the biological information, features are extracted from the classified biological information by applying feature extraction methods defined respectively for the plurality of groups, and feature-extracted biological information is enrolled for each of the plurality of groups.

13. An authentication method characterized in that biological information to be referred to is enrolled beforehand for each of a plurality of groups defined on the basis of individual differences of the biological information and while the biological information inputted is being classified into any of the plurality of groups, features are extracted from the classified biological information by applying feature extraction methods defined respectively for the plurality of groups, and feature-extracted biological information is authenticated by referring to biological information to be referred to corresponding to a group that contains the classified biological information.

14. An enrollment apparatus, comprising:
a biological information acquiring unit which gathers biological information intrinsic to a human body, from a predetermined region of body;
an index value calculating unit which calculates an index value where the biological information is put into indices by a predetermined criterion;
a group specifying unit which detects to which of a plurality of groups the calculated index value belongs, by referring to a predetermined classification table in which a range of the index value is divided into the plurality of groups;
a storage region specifying unit which specifies a storage region corresponding to the detected group among a plurality of storage regions respectively associated with the plurality of groups;
a biological information recording unit which records the gathered biological information in the specified storage region; and
a boundary condition determining unit which determines whether a boundary condition holds or not based on whether or not the calculated index value lies within a predetermined value from a boundary of the detected group,
wherein when the boundary condition holds, said storage region specifying unit specifies two storage regions corresponding respectively to two groups that lie across the boundary, and
wherein when the boundary condition holds, said biological information recording unit records the gathered biological information in the specified two storage regions, respectively.

15. An enrollment apparatus, comprising:
a biological information acquiring unit which gathers biological information intrinsic to a human body, from a predetermined region of body;
an index value calculating unit which calculates a first index value and a second index value where the biological information is put into indices respectively by two criteria;
a first group specifying unit which detects to which of a plurality of groups of first kind the calculated first index value belongs, by referring to a first classification table in which a range of the first index value is divided into the plurality of groups of first kind;
a first storage region specifying unit which specifies a storage region of first kind, corresponding to the detected group of first kind, among a plurality of storage regions of first kind corresponding respectively to the plurality of groups of first kind;
a second group specifying unit which detects to which of a plurality of groups of second kind the calculated second index value belongs, by referring to a second classification table in which a range of the second index value is divided into the plurality of groups of second kind;
a second storage region specifying unit which specifies a storage region of second kind, corresponding to the detected group of second kind, among a plurality of storage regions of second kind corresponding respectively to the plurality of groups of second kind; and
a biological information recording unit which records the gathered biological information in the specified storage regions of first kind and second kind, respectively.

16. An authentication apparatus, comprising:
a biological information acquiring unit which gathers biological information intrinsic to an authenticatee, from a predetermined region of body;
an index value calculating unit which calculates a index value where the biological information is put into indices by a predetermined criterion;
a group specifying unit which detects to which of a plurality of groups the calculated index value belongs, by referring to a predetermined classification table in which a range of the index value is divided into the plurality of groups;
a storage region specifying unit which specifies a storage region corresponding to the detected group among a plurality of storage regions respectively associated with the plurality of groups;
a biological information storage unit which stores biological information on a same registrant in two or more storage regions separately; and
an authentication unit which authenticates the authenticatee by checking the biological information gathered from the authenticatee against biological information, on a registrant, stored in the specified storage region,
wherein when authentication of the authenticatee fails, said authentication unit checks the biological information on the authenticatee against biological information, on the registrant, stored in a storage region that differs from the specified storage region.

17. An authentication apparatus according to claim 16, further comprising a boundary condition determining unit which determines whether a boundary condition holds or not based on whether or not the calculated index value lies within a predetermined value from a boundary of the detected group,
wherein when the boundary condition holds, said storage region specifying unit specifies two storage regions corresponding respectively to two groups that lie across the boundary, and
wherein when the boundary condition holds, said authentication unit checks the biological information on the authenticatee against the biological information, on the registrant, stored in the specified two storage regions.

18. An authentication apparatus, comprising:
a biological information acquiring unit which gathers biological information intrinsic to a human body, from a predetermined region of body;
an index value calculating unit which calculates a first index value and a second index value where the biological information is put into indices respectively by two criteria;
a first group specifying unit which detects to which of a plurality of groups of first kind the calculated first index value belongs, by referring to a first classification table in which a range of the first index value is divided into the plurality of groups of first kind;
a first storage region specifying unit which specifies a storage region of first kind, corresponding to the detected group of first kind, among a plurality of storage regions of first kind corresponding respectively to the plurality of groups of first kind;
a second group specifying unit which detects to which of a plurality of groups of second kind the calculated second index value belongs, by referring to a second classification table in which a range of the second index value is divided into the plurality of groups of second kind;
a second storage region specifying unit which specifies a storage region of second kind, corresponding to the detected group of second kind, among a plurality of storage regions of second kind corresponding respectively to the plurality of groups of second kind;
a biological information storage unit which stores biological information on a same registrant in the storage region of first kind and the storage region of second kind separately; and
an authentication unit which authenticates an authenticatee by checking the biological information gathered from the authenticatee against biological information, on a registrant, stored in the specified storage regions of first kind and second kind.
